(19) United States
(12) Patent Application Publication
(10) Pub. No.: US 2014/0346119 A1
(43) Pub. Date: Nov. 27, 2014

(54) METHOD FOR OPERATING AN OIL FILTER SYSTEM

(71) Applicant: Audi AG, Ingolstadt (DE)

(72) Inventors: STEFAN AMMLER, Bergheim (DE); DIETMAR SCHULLER, Altmannstein (DE); HANS-PETER FLEISCHMANN, Stammham (DE)

(73) Assignee: Audi AG, Ingolstadt (DE)

(21) Appl. No.: 14/285,073

(22) Filed: May 22, 2014

(30) Foreign Application Priority Data
May 23, 2013 (DE) 102013008739.2

(51) Int. Cl. B01D 37/04

(52) U.S. Cl. CPC B01D 37/04
USPC 210/739

(57) ABSTRACT

A transmission assembly has a clutch or brake, an oil filter, an electrically driven hydraulic pump and a controller controlling the pump. In the method for operating an oil filter system for transmission oil, the actual contamination level Vₐ (%) of the transmission oil is determined indirectly by a contamination model Vₐ (%)=Vₛₜₐᵣₜ(IW %)−A (%)+B (%)+C (%), wherein Vₛₜₐᵣₜ (IW %) is a starting contamination value, A (%) depends on the hydraulic pump flow rate, B (%) depends on a clutch energy input, and C (%) depends on a transmission performance. When a contamination threshold value Vₛ (%) is exceeded, the hydraulic pump is switched on, until the actual contamination level Vₐ (%), after decrementing by A (%) in the contamination model, is equal to or less than the contamination level threshold value Vₐ (%) minus a fixed hysteresis value V_{H} (%).

### CROSS-REFERENCES TO RELATED APPLICATIONS

This application claims the priority of German Patent Application, Serial No. 10 2013 008 739.2, filed May 23, 2013, pursuant to 35 U.S.C. 119(a)-(d), the content of which is incorporated herein by reference in its entirety as if fully set forth herein.

### BACKGROUND OF THE INVENTION

The present invention relates to a method for operating an oil filter system for transmission oil of a transmission assembly with a clutch or brake.

The following discussion of related art is provided to assist the reader in understanding the advantages of the invention, and is not to be construed as an admission that this related art is prior art to this invention.

A conventional oil filter system includes a filter circuit having at least one oil filter, a hydraulic pump, an electric with an electric or electrically superimposed drive and a controller. An Automatic Transmission Fluid (ATF) is hereby filtered in the transmission in a conventional manner and only, when the electrically driven hydraulic pump is operated based on a pressure demand or a cooling demand, or for example the mechanical drive is activated with a superimposed drive.

Disadvantageously, with this method for operating the oil filter system for the ATF, filter demands due to original contamination caused by oil contamination during manufacture, as well as filter demands caused by wear, especially by clutch wear, are not taken into consideration.

It would therefore be desirable and advantageous to obviate prior art shortcomings and to provide an improved method for operating an oil filter system for transmission oil a transmission assembly having a clutch or brake, with which the transmission oil is filtered as needed depending on the ingress of contaminants.

### SUMMARY OF THE INVENTION

According to one aspect of the present invention, an actual contamination level Vₐ (%) of the transmission oil is indirectly determined by a contamination model via a relationship Vₐ (%)=Vₛₜₐᵣₜ(IW %)−A (%)+B (%)+C (%), wherein Vₛₜₐᵣₜ (IW %) is a starting contamination value based on an initial original contamination value IW % that can be freely selected during manufacture/final inspection for an initial system startup, A (%) is a percentage of a cleaning level of the oil that is a function of a hydraulic pump flow rate, B (%) is a percentage of a contamination level of the oil that is a function of a clutch energy input, and C (%) is a percentage of a contamination level the oil that is a function of the transmission performance.

The contamination model is initialized at the production/final acceptance stage of the transmission assembly for an initial system startup to an arbitrarily selectable initial value according to Vₛₜₐᵣₜ (IW %) by taking into account the original contamination, i.e. by taking into account a production-related contamination level. Thereafter, the contamination model is decremented by A (%), causing the contamination level to decrease, as well as incremented by B (%) and C (%), causing the contamination level to increase.

In the further course of the method, the actual contamination level Vₐ (%) is compared with a specified contamination level threshold value Vₛ (%), wherein the drive of the hydraulic pump for the filter circuit is activated and turned on when the threshold value Vₛ (%) is exceeded. The contamination level Vₐ (%) is reduced by decrementing with A (%) until the actual determined contamination level Vₐ (%) is less than the contamination level threshold value Vₛ minus a defined hysteresis value V_{H} (%).

The actual contamination level (Vₐ) is stored in a nonvolatile memory of the controller and is used in a subsequent system startup as an initial starting value (Vₛₜₐᵣₜ).

By using the contamination model according to the invention, a complex measurement device prone to large measurement tolerances for directly measuring the contamination level of the oil can be eliminated. Furthermore, the filter device is then operated only when required by the determined contamination level of the oil. This results in an expedient demand-based oil service in an energy-efficient operation of the oil filter system.

According to an advantageous feature of the present invention, the activation and control of the electric pump drive may be enabled only when the actual state of charge of a battery or the load state of a generator is above a threshold value, which is determined in particular with respect to a positive CO₂ balance.

According to another advantageous feature of the present invention, the oil temperature may be measured and an oil temperature-dependent rotational speed for the operation of the hydraulic pump may be requested during the activation, wherein the dependence of the rotational speed from the oil temperature can be defined specific for the assembly.

The percentage A (%) in the contamination model that reduces the contamination level as a function of the pump flow rate can advantageously be formed by determining the oil flow rate through the filter circuit from the measured pump rotational speed, the pump running time and the known pump stroke volume. This flow rate is then multiplied by a weighting factor that takes into account the specific situation relating to the filtering effect.

According to another advantageous feature of the present invention, the percentage B (%) that increases the contamination level of the oil as a function of the clutch energy input may be readily determined by multiplying the measured clutch energy input, expressed as (power times time), by a weighting factor that takes into account the concrete conditions that increase the contamination level.

Likewise, the percentage C (%) of the contamination level of the oil caused by the transmission performance since the last calculation may be readily determined as a function of the transmission performance by multiplying the transmission performance with a weighting factor that takes into account the specific circumstances for this increase of the oil contamination.

The method relates particularly to transmission oil in form of a so-called ATF-oil (Automatic Transmission Fluid) in an automatic transmission with an internal filter of a motor vehicle.

### BRIEF DESCRIPTION OF THE DRAWING

Other features and advantages of the present invention will be more readily apparent upon reading the following description of actually preferred exemplified embodiments of the invention with reference to the accompanying drawing, in which:

FIG. 1 is schematic diagram a transmission assembly according to the present invention; and

FIG. 2 is flow diagram of the method according to the present invention.

### DETAILED DESCRIPTION OF PREFERRED EMBODIMENTS

The depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

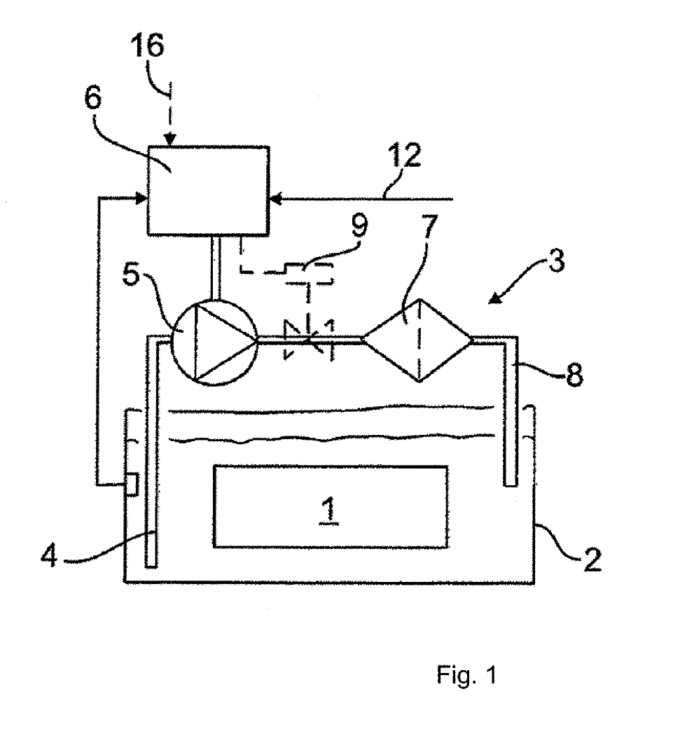

Turning now to FIG. 1, there is shown a transmission assembly (not shown in detail) with a clutch 1 located in a transmission oil sump 2 and an oil filter system 3.

The oil filter system 3 includes a pump inlet 4 connected to a hydraulic pump 5 which is electrically operated and controlled by a controller 6 via a control line 12.

An oil filter 7 is arranged downstream of the hydraulic pump 5, with the output of the oil filter 7 connected via an oil outlet line 8 to the transmission oil sump 2,

In addition, where appropriate, controllable shut-off or multi-way valves may be provided in particular for oil bypass lines, wherein an exemplary valve 9 is indicated here by a dashed line. The positions of these valves 9 are to be considered in the following contamination model in particular when determining A (%) as a function of the pump flow rate through the oil filter 7.

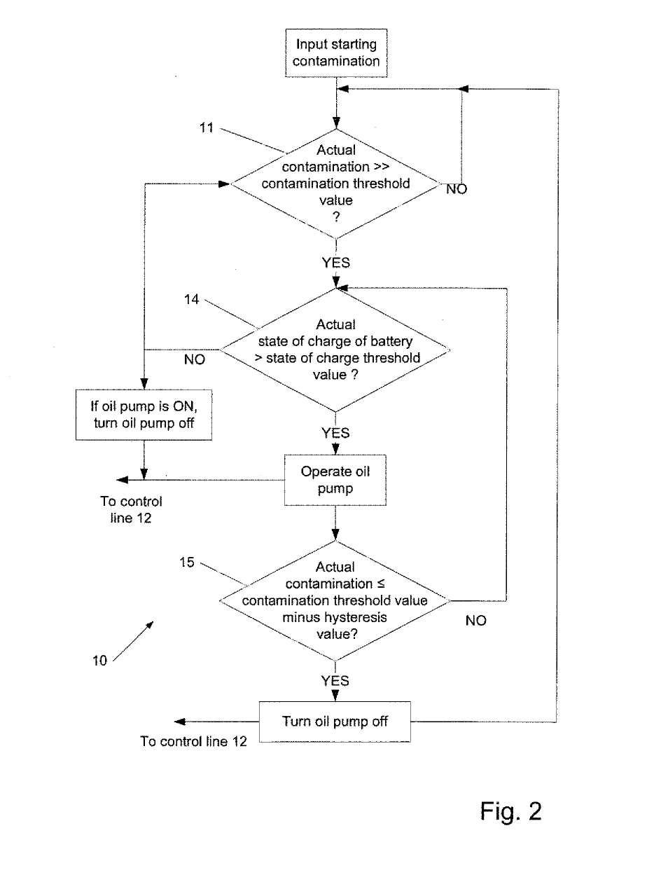

FIG. 2 shows a schematic flow diagram 10 for operating the controller 6, in particular for determining an actual contamination level Vₐ (%) of the oil by way of a contamination model:

To this end, a starting contamination of 100% is initially specified for a first system start with a freely selectable initial value IW % after manufacture/delivery, from which a percentage A (%) representing a cleaning level of the oil based on the pump flow rate is decremented. Conversely, a percentage B (%) representing an increase of the oil contamination caused by clutch wear and a corresponding percentage C (%) representing an increase caused by transmission performance are incremented in the contamination model. The last actual contamination level stored in non-volatile memory is then used as the starting value for each of the subsequent system startups.

At step 11 of the flow diagram 10, it is determined whether the actual contamination level Vₐ (%) has risen to a value higher than a predetermined contamination threshold value Vₛ (%). If this is the case, the hydraulic pump 5 for filtering the oil should be turned by the controller 6 via the control line 12.

However, this should only be possible when it is determined at step 14 that an actual state of charge La of the battery for operating the electric pump drive is greater than a predetermined state of charge threshold value Ls.

The hydraulic pump remains switched on commensurate with step 13, until due to the operation of the oil filter system 3 the actual contamination level Vₐ is reduced below the contamination threshold value V_{$} by a hysteresis value V_{H}.

The hydraulic pump 5 can optionally be also switched on as a function of other criteria, as indicated schematically by the dashed arrow 16 in FIG. 1. Such activation of a pump is also taken into account when determining the percentage A (%) of the oil cleaning level and thus when determining the actual contamination level Vₐ (%).

While the invention has been illustrated and described in connection with actually preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for operating an oil filter system for transmission oil of a transmission assembly having a clutch or a brake, as well as a filter circuit having at least one oil filter and a hydraulic pump with an electric drive or an electrically superimposed drive and controller, wherein the drive of the hydraulic pump is controlled and turned on by the controller, the method comprising the steps of:
providing a contamination model for indirectly determining an actual contamination level Vₐ (%) of the transmission oil via a relationship
Vₐ (%)=Vₛₜₐᵣₜ(IW %)−A (%)+B (%)+C (%),
wherein
Vₛₜₐᵣₜ (IW %) is a starting contamination value based on an initial original contamination value IW % that is freely selectable for an initial system startup during manufacture/final inspection,
A (%) is an oil cleaning level percentage that is a function of a hydraulic pump flow rate,
B (%) is an oil contamination level percentage that is a function of a clutch energy input, and
C (%) is an oil contamination level percentage that is a function of a transmission performance;
initializing the contamination model with the initial starting contamination value Vₛₜₐᵣₜ (IW %);
decrementing the initial starting contamination value Vₛₜₐᵣₜ (IW %) by A (%) and incrementing Vₛₜₐᵣₜ (IW %) by B (%) and C (%) to compute the actual contamination level Vₐ (%);
defining a contamination level threshold value Vₛ (%) and comparing the contamination level threshold value Vₛ (%) with the actual contamination level Vₐ (%);
when the actual contamination level Vₐ (%) exceeds the contamination level threshold value Vₐ (%), switching the drive of the hydraulic pump on and controlling the drive of the hydraulic pump until the actual contamination level Vₐ (%), as computed by decrementing with A (%) in the contamination model, is equal to or less than the contamination level threshold value Vₐ (%) minus a fixed hysteresis value V_{H} (%);
storing the actual contamination level Vₐ (%) in a nonvolatile memory of the controller; and
using the stored actual contamination level Vₐ in a subsequent system startup;

2. The method of claim 1, wherein the drive of the hydraulic pump is switched on and controlled only when an actual state of charge of a battery or a load state of a generator lies above an actually determined threshold value.

3. The method of claim 1, further comprising
measuring an oil temperature; and
specifying with the controller an oil-temperature-dependent rotational speed of the hydraulic pump.

4. The method of claim 1, wherein the oil cleaning level percentage A (%) is determined by A (%)=pump flow rate·x,
wherein x is a weighting factor taking into account an actual operating condition.

5. The method of claim 1, wherein the oil contamination level percentage B (%) is determined by B (%)=clutch energy input·y,
wherein y is a weighting factor taking into account an actual operating condition.

6. The method of claim 1, wherein the oil contamination level percentage C (%) is determined by C (%)=transmission performance·z,
wherein z is a weighting factor taking into account an actual operating condition.

7. The method of claim 6, wherein the oil contamination level percentage C (%) is determined from a change in the oil contamination level percentage C (%) due to the transmission performance since an immediately preceding computation of the actual contamination level V ₐ (%).

8. The method of claim 1, wherein the transmission oil is an automatic transmission fluid (ATF) in an automatic transmission of a motor vehicle having an internal filter.

9. The method of claim 1, wherein the drive of the hydraulic pump is energized by at least one of a traction battery, an onboard system battery, and a generator configured to supply power to the onboard system.
